(19) United States
(12) Patent Application Publication
(10) Pub. No.: US 2009/0084038 A1
(43) Pub. Date: Apr. 2, 2009

(54) Device for preventing persons from boarding a vehicle, more specifically a bus, through a door opening

(75) Inventor: Thorsten Sprenger, Lohfelden (DE)

Correspondence Address: PYLE & PIONTEK;ATTN: THOMAS R. VIGIL, 221 N LASALLE STREET , ROOM 2036, ROOM 2036, CHICAGO, IL, 60601, US

(73) Assignee: Hubner GmbH, Kassel (DE)

(21) Appl. No.: 11/894,902

(22) Filed: Aug. 22, 2007

(51) Int. Cl. B60N 5/00; F16C 32/00

(52) U.S. Cl. 49/49; 384/2

(57) ABSTRACT

The subject matter of the invention is a device for preventing persons from boarding a vehicle, more specifically a bus, through the open door opening, said device including a stopper system (10) that is pivotal outward from the interior of the vehicle, said stopper system (10) including two rows of a plurality of arms that are arranged on top of one another said arms (20) are individually pivotable toward the outside, said arms (20), which are lying on one plane with respect to one another, being oriented so as to point angularly outward.

### 1. FIELD OF THE INVENTION

The invention relates to a device for preventing persons from boarding a vehicle, more specifically a bus, through the open door opening, said device including a stopper system that is pivotal outward from the interior of the vehicle, said stopper system including two rows of arms arranged on top of one another.

### 2. DESCRIPTION OF THE PRIOR ART

The document FR 2 053 549 shows a stopper system for a passage with two frames that are inclined at an angle with respect to each other and are pivoted in one direction for opening the passage.

A passage stopping device is known from the document DE 43 05 325 A1, said device including a plurality of arms arranged one on top of the other, said arms being configured to be pivotal all together.

The boarding region at the front door of a bus is divided into two parts, with the boarding part passing directly in front of the bus driver being designed to be the only possibility for the boarding persons to enter the bus whilst the alighting part, which runs parallel thereto, is designed to be accessible for alighting persons only. Boarding and alighting region at the front door are provided with stopper systems allowing passage in one direction only. More specifically, such a stopper system is a pivotal arm that is pivotal in one direction only.

This configuration of the door boarding region as it has just been described substantially serves for allowing smooth boarding and alighting of persons.

Busses and other vehicles however not only have a front door opening, but at least one or more rear door openings the access through which, when open, cannot be monitored by the bus driver. For this reason, the rear doors of a bus remain closed, particularly at night, in order to ensure that the persons boarding the bus pass directly in front of the bus driver for control. At night, this is no problem since the number of passengers boarding or alighting the bus is usually small.

The situation however is completely different when during peak hours it has to be ensured that e.g., the rear door opening only serves for alighting whereas the front door opening is for boarding only for the bus driver to control boarding passengers. This boarding and alighting management of persons, in busses in particular, is desirable in terms of security. In the Middle East, in Israel in particular, it is known that suicide attackers board busses with bombs which they ignite once in the bus. In these countries the bus drivers are trained to recognize and to refuse to admit such persons when these persons are forced to pass in front of the driver on boarding the bus. This procedure however is no longer ensured when the rear bus door is open with any person being allowed to board or alight. It has been found that a simple stopper system in the form of an arm that is pivotal in one direction in the rear door region is not capable of reliably preventing persons from boarding the bus since this arm can be readily pivoted outward with one hand by a person determined to board the bus.

### SUMMARY OF THE INVENTION

It is therefore the object of the invention to provide a device of the type mentioned herein above and by means of which persons are refused admission on the bus with reasonable expense while making it possible for persons on board the bus to readily alight like before.

This object is solved, in accordance with the invention, in that the arms are individually pivotable outward, with said arms, which are lying on one plane with respect to one another, being oriented so as to point angularly outward. By arranging five or more arm pairs on top of one another, each arm pair including two arms lying in one plane, being inclined at an angle to each other and substantially almost contacting each other at their ends so that they are not allowed to be pivoted inward, persons are reliably prevented from boarding a bus since the person would have to pivot every single arm outward, said person only having two arms or hands to do so. In the case of five or more arm pairs of the type mentioned herein above arranged on top of one another, said arms or arm pairs would have to be pivoted more or less simultaneously to allow admission; this is impossible or would only be possible at the expense of considerable measures that would be noticed by the other passengers. It is very probable that in such a case the other passengers would defensively intervene to prevent the person of concern from actually boarding the bus.

Advantageous features of the invention will become apparent in the subordinate claims.

More specifically, there is provided that the arms, which are arranged on top of one another, be arranged on a post, more specifically on a rotary post. As already explained herein above, the arms are individually pivotable, that is to say that the arms are individually and pivotally disposed on the rotary post. Configuring the post to be a rotary post offers the possibility to pivot the whole post for whatever reason in order to generally pivot the arms out of the boarding region of the door for unhindered access to the bus. In order to preclude unauthorized pivotal movement of the posts, said posts can be locked so that pivoting them is only possible using a key.

With respect to the arrangement of the individual pivotal arms, more specifically on the post and in the present case more specifically on a rotary post, there is provided that each arm is retained by a pivot bearing. Such a pivot bearing comprises a claw by means of which it is received by the post, said claw having a bolt for rotating an arm receiving stub, said stub being rotatable on the bolt against the force of a spring. This is to make certain that once the discrete arms have been pivoted outward toward the outboard side of the bus these arms immediately return to their initial position under the action of the spring. In order to further ensure that the arms return to a defined initial position after having been pivoted outward, there is provided that every single stub abuts a corresponding limit stop in the closed position of the arm.

As already explained herein above, the invention aims at providing the possibility of generally pivoting the arms. In this context, there is provided that the rotary post is secured by a catch device in at least one second position. Meaning, the arms can have two positions, viz. a first position in which the arms prevent persons from boarding and one second pivoted position of the arms in which the arms allow admission on the bus.

In this context, the catch device includes a sleeve-shaped saddle surrounding the rotary post, said rotary post being rotatable relative to the saddle, said saddle being non-rotatably linked to the vehicle, said rotary post comprising a ring that is axially displaceable on the rotary post but non-rotatably linked thereto and that is interlockable with the saddle. It will be obvious therefrom that by rotating the ring, which constitutes a unit with the rotary post, it is possible to generally rotate the rotary post, the saddle comprising, on its side turned toward the ring, at least one recess for receiving a lug disposed on the ring in order to allow for an interlocking connection between saddle and ring for the purpose of stopping the rotary post. In order to make certain that the ring remains seated on the saddle in spite of jerks there is provided that the ring is axially displaceable against the force of a spring. However, there is provided that the ring is lockable to the saddle, preferably through a lock with a key so that authorized persons only may open the device for preventing persons from boarding a vehicle through the door opening.

The invention is explained by way of example in greater detail herein after with reference to the drawings.

### BRIEF DESCRIPTION OF THE DRAWING

FIG. 1 perspectively shows the boarding region of a bus provided with the device of the invention;

FIG. 2 shows a sectional side view of the pivot bearing;

FIG. 3 shows a top view of the pivot bearing in accordance with FIG. 2;

FIG. 4 shows the catch device on the rotary post with the pivot bearing being outlined;

FIG. 5 shows the catch device in another position.

### DETAILED DESCRIPTION OF THE INVENTION

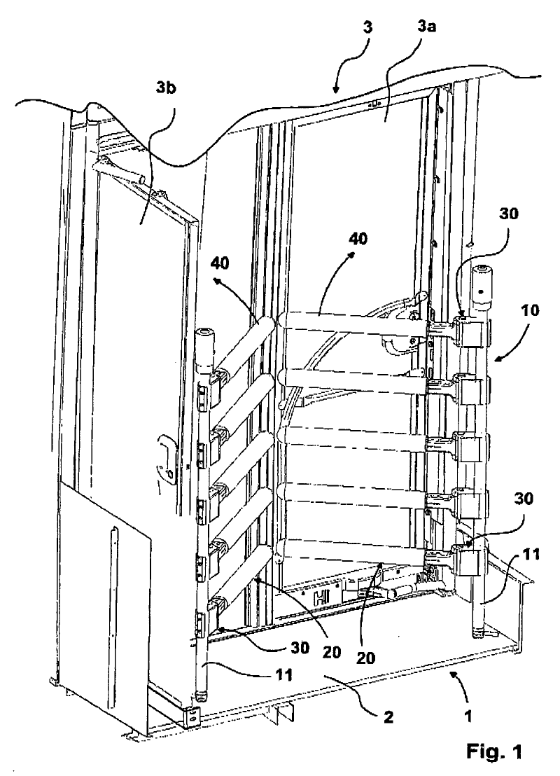

In accordance with FIG. 1, the boarding region, indicated generally at 1, comprises the boarding platform 2 of the bus as well as a two-leaf swing door 3 with the two door leaves 3a and 3b, the door leaf 3b being in the open position in FIG. 1.

The actual device for preventing a person from boarding a vehicle through the door opening is indicated generally at 10. This device includes two rotary posts 11, each comprising five arms arranged on top of one another and indicated generally at 20. Every single arm 20 is connected to the rotary post 11 through a pivot bearing 30.

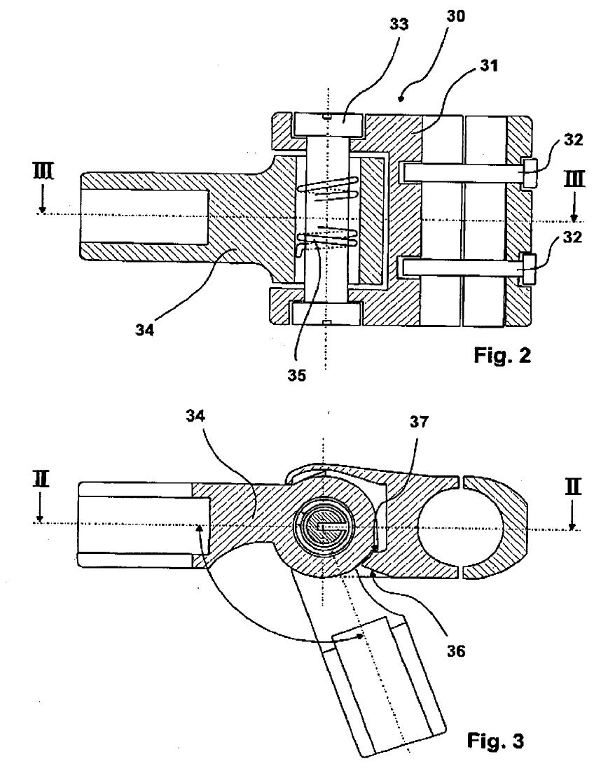

The configuration of the pivot bearing 30 becomes apparent upon reviewing the FIGS. 2 and 3. The pivot bearing 30 includes a claw 31 for connection with the rotary post 11. The claw is frictionally connected to the rotary post by means of the screws 32. The claw moreover possesses the bolt 33 about which the stub 34 is rotatably carried against the force of the spiral spring 35. The stub 34 receives the arm 20 (not shown in FIG. 2). In order to make certain that the stub 34 only rotates in one direction of rotation, there is provided a limit stop 36 cooperating with a lug 37 provided on the stub 34; this can be seen from FIG. 3.

The important point of the invention is that the two rows of arms, which are each individually and pivotally disposed on a rotary post and are, as a result thereof, also individually pivotable in the direction of the arrow 40, are arranged in pairs in one plane and inclined at an outward directed angle to one another so that pivotal motion is actually only ensured in the direction of the arrow 40 and not in the opposite direction. This means that the arms 20 are directed angularly outward as is evident from FIG. 1.

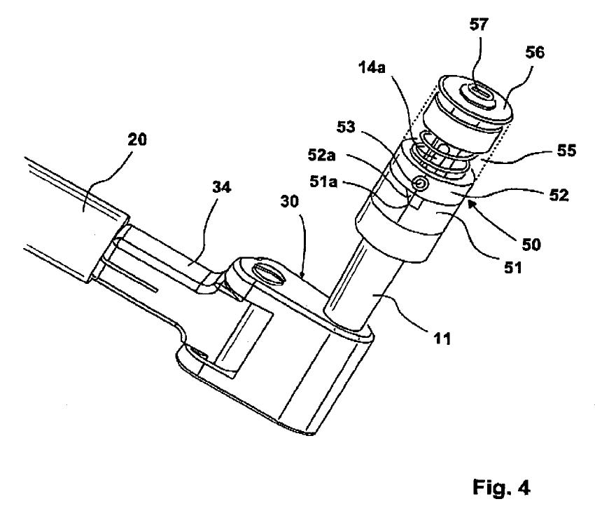

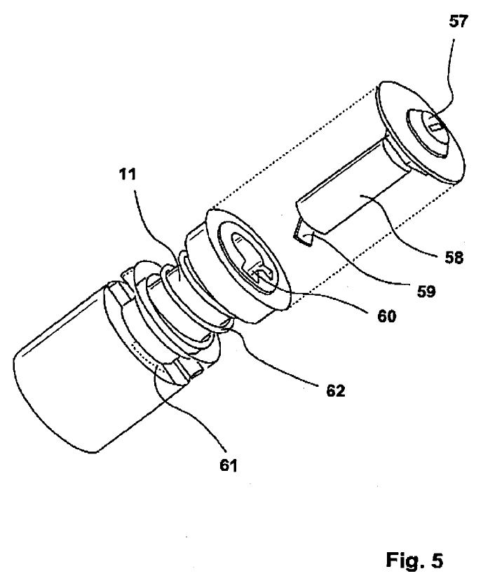

As already explained herein above, the invention aims at providing the possibility to generally displace the rotary post 11 and, as a result thereof, also the arms 20 in order to allow for unhindered access to the bus. In this context, reference is made to the FIGS. 4 and 5. The rotary post indicated at 11 comprises at its upper end the catch device indicated generally at 50. The catch device 50 includes the sleeve-shaped saddle 51 that is non-rotatably linked to the vehicle but also allows for rotation of the rotary post 11 relative to the sleeve-shaped saddle. The ring 52, which is non-rotatably connected to the rotary post, is seated on the saddle. For this purpose, the ring 52 has a socket screw 53 that engages a groove labelled at 11a and provided in the rotary post. On top of it there is located a sleeve 55 comprising at its upper end the lock cover 56 with the lock 57.

As can be seen from FIG. 5, the lock 57 includes a cylinder 58 exhibiting a protruding lug 59 at its end. Said lug 59 passes through a cutout 60 before it engages behind a groove 61. By rotating the cylinder, said lug 59 can be moved into or out of engagement with the groove 61. Next, the sleeve 55 can be displaced upward, which makes it possible to displace the ring 52 against the force of the spring 62 along the rotary post 11 in order to move the lug 52a of the ring 52 out of engagement with the recess 51a of the sleeve-shaped saddle. After rotating the ring 50, and, as a result thereof, the rotary post 11, by a certain angle, for example 90.degree, there is another recess 51a on the sleeve 51 for the lug to enter into in order to fixate the rotary post in this position.

I claim:

1. A device for preventing persons from boarding a vehicle, more specifically a bus, through the open door opening, said device including a stopper system (10) that is pivotal outward from the interior of the vehicle, said stopper system (10) including two rows of a plurality of arms that are arranged on top of one another wherein said arms (20) are individually pivotable toward the outside, said arms (20), which are lying on one plane with respect to one another, being oriented so as to point angularly outward.

2. The device as set forth in claim 1, wherein the arms (20), which are arranged on top of one another, are disposed respectively on a post (11).

3. The device as set forth in claim 2, wherein the post is configured to be a rotary post (11).

4. The device as set forth in claim 3, wherein the rotary post (11) is rotatable and is securable in at least one second position through a catch device (50).

5. The device as set forth in claim 1, wherein each arm (20) is retained by a pivot bearing (30).

6. The device as set forth in claim 5, wherein the pivot bearing (30) comprises a claw (31) by means of which it is received by the post (11), said claw (31) having a bolt (33) for rotating a stub (34) receiving the arm (20), said stub (34) being rotatable on said bolt (33) against the force of a spring (35).

7. The device as set forth in claim 6, wherein in the closed position of the arm (20), the stub (34) abuts a limit stop (36).

8. The device as set forth in claim 4, wherein the catch device (50) includes a sleeve-shaped saddle (51) surrounding the rotary post (11), said rotary post (11) being rotatable relative to said saddle (51), said saddle (51) being non-rotatably linked to the vehicle, said rotary post (11) comprising a ring (52) that is axially displaceable on said rotary post (11) but non-rotatably linked thereto (11) and that is interlockable with said saddle (51).

9. The device as set forth in claim 8, wherein the saddle (51) is turned toward the ring (52) and comprises at least one recess (51a) for receiving a lug (52a) disposed on said ring (52).

10. The device as set forth in claim 8, wherein the ring (52) is axially displaceable against the force of a spring (62).

11. The device as set forth in claim 8, wherein the ring (52) is lockable to the saddle (51).

12. The device as set forth in claim 1, wherein a lock (57) is provided for locking.
